(19) United States
(12) Patent Application Publication
(10) Pub. No.: US 2018/0189902 A1
(43) Pub. Date: Jul. 5, 2018

(54) Earth Invest Score for Home Prices

(71) Applicant: Cyrus Afshar, Washington, DC (US)

(72) Inventor: Cyrus Afshar, Washington, DC (US)

(21) Appl. No.: 15/396,355

(22) Filed: Dec. 30, 2016

(51) Int. Cl. G06Q 50/16; G06Q 30/02

(52) U.S. Cl. CPC G06Q 50/16; G06Q 30/0206; G06Q 30/0205

(57) ABSTRACT

A method for determining whether home prices (or a home price index or home price indices) are more likely to rise or fall. A plurality of factor scores, based on a plurality of factors, is determined. An aggregate score, based on a plurality of factor scores, is then determined.

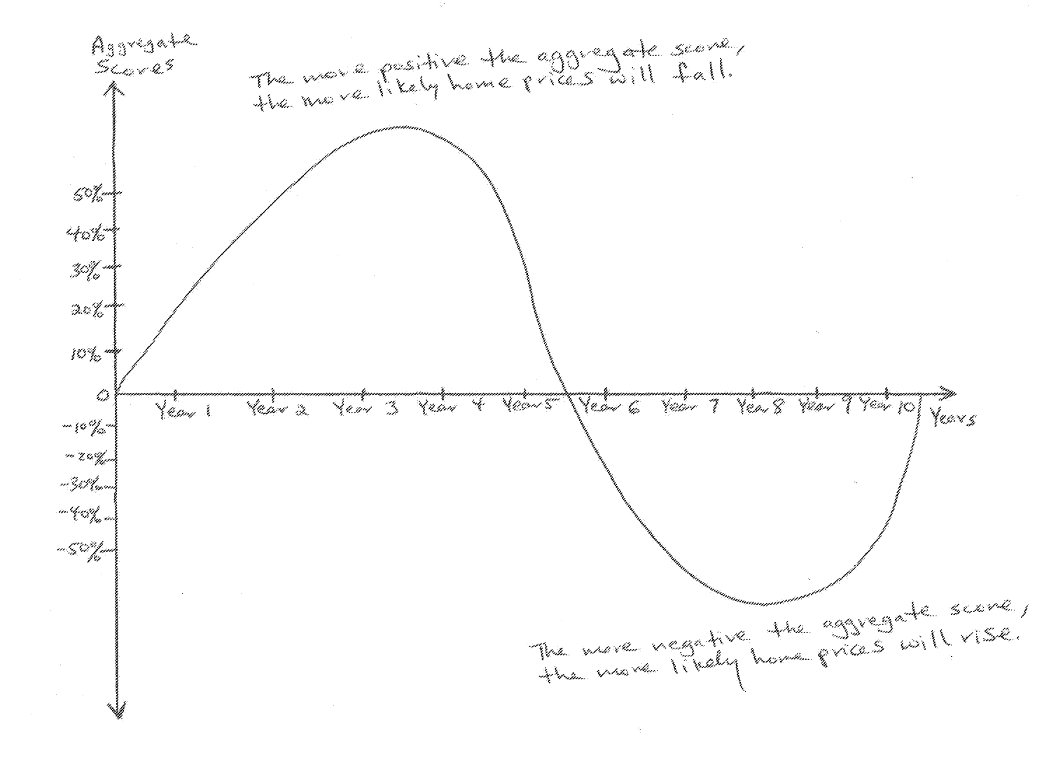

### CROSS-REFERENCE TO RELATED APPLICATIONS

This application claims the benefit of U.S. Provisional Patent Application No. 62/274,151, entitled “Earth Invest Score for Home Prices,” filed on Dec. 31, 2015.

### BACKGROUND OF THE INVENTION

This invention pertains to investing and most likely belongs in one of the three patent classifications below:

### 1. Class 705, Subclass 35;

### 2. Class 705, Subclass 36; or

### 3. Class 705, Subclass 37.

### BRIEF SUMMARY OF THE INVENTION

Almost all news sources for home prices (or a home price index or home price indices) describe what has already occurred in the market. For example, they'll describe home price changes that occurred over the previous month or quarter or year. These after-the-fact descriptions are not very useful.

The purpose of this invention is to create an aggregate score of useful forward-looking home prices information.

This invention uses time-tested value investing principles to help identify whether home prices are more likely to rise or fall. Value investing is based on the notion that there is a long term fundamental value for every investment. In the short term, the market overreacts to good news and bad news, but in the long term, every investment returns to its fundamental value.

This invention helps to identify the long term fundamental value of home prices by using ratios of key market variables. This invention compares the current values of these ratios to their historic averages to help identify whether home prices are more likely to rise or fall.

### BRIEF DESCRIPTION OF THE SINGLE VIEW OF THE DRAWING

The drawing portrays exemplary embodiment #1, from the Detailed Description of the Invention, in a graphical form.

The more positive the aggregate score, the more likely home prices will fall.

The more negative the aggregate score, the more likely home prices will rise.

### DETAILED DESCRIPTION OF THE INVENTION

Various embodiments of this invention are described below to:

(a) Determine a plurality of factor scores, based on a plurality of factors; and
(b) Determine an aggregate score, based on a plurality of factor scores.
1. In one exemplary embodiment, the following steps are taken:
Step 1: Current Values
(a) Calculate (Home Prices)÷(Family Incomes);
(b) Calculate (Mortgage Payments)÷(Family Incomes);
(c) Calculate (Home Prices)÷(Home Rents); and
(d) Calculate (Mortgage Payments)÷(Home Rents).
Step 2: Historic Values
(a) Calculate the 5-year trailing average (or 5-year projected average or a hybrid of trailing and projected averages) of (Home Prices)÷(Family Incomes);
(b) Calculate the 5-year trailing average (or 5-year projected average or a hybrid of trailing and projected averages) of (Mortgage Payments)÷(Family Incomes);
(c) Calculate the 5-year trailing average (or 5-year projected average or a hybrid of trailing and projected averages) of (Home Prices)÷(Home Rents); and
(d) Calculate the 5-year trailing average (or 5-year projected average or a hybrid of trailing and projected averages) of (Mortgage Payments)÷(Home Rents).
Step 3: Historic Values
(a) Calculate the 10-year trailing average (or 10-year projected average or a hybrid of trailing and projected averages) of (Home Prices)÷(Family Incomes);
(b) Calculate the 10-year trailing average (or 10-year projected average or a hybrid of trailing and projected averages) of (Mortgage Payments)÷(Family Incomes);
(c) Calculate the 10-year trailing average (or 10-year projected average or a hybrid of trailing and projected averages) of (Home Prices)÷(Home Rents); and
(d) Calculate the 10-year trailing average (or 10-year projected average or a hybrid of trailing and projected averages) of (Mortgage Payments)÷(Home Rents).
Step 4: Factor Scores
(a) Calculate the percentage difference between Step 1 (a) and Step 2 (a).
   The percentage difference=(Home Prices)÷(Family Incomes) compared to 5-year average factor score;
(b) Calculate the percentage difference between Step 1 (b) and Step 2 (b).
   The percentage difference=(Mortgage Payments)÷(Family Incomes) compared to 5-year average factor score;
(c) Calculate the percentage difference between Step 1 (c) and Step 2 (c).
   The percentage difference=(Home Prices)÷(Home Rents) compared to 5-year average factor score; and
(d) Calculate the percentage difference between Step 1 (d) and Step 2 (d).
   The percentage difference=(Mortgage Payments)÷(Home Rents) compared to 5-year average factor score.
Step 5: Factor Scores
(a) Calculate the percentage difference between Step 1 (a) and Step 3 (a).
   The percentage difference=(Home Prices)÷(Family Incomes) compared to 10-year average factor score;
(b) Calculate the percentage difference between Step 1 (b) and Step 3 (b).
   The percentage difference=(Mortgage Payments)÷(Family Incomes) compared to 10-year average factor score;
(c) Calculate the percentage difference between Step 1 (c) and Step 3 (c).
   The percentage difference=(Home Prices)=(Home Rents) compared to 10-year average factor score; and
(d) Calculate the percentage difference between Step 1 (d) and Step 3 (d).
   The percentage difference=(Mortgage Payments)÷(Home Rents) compared to 10-year average factor score.
Step 6: Aggregate Score
(a) Calculate the average of Step 4 (a), Step 4 (b), Step 4 (c), Step 4(d), Step 5 (a), Step 5 (b), Step 5 (c), and Step 5 (d).
   The average of the factor scores=the aggregate score.
   The more positive the aggregate score, the more likely home prices will fall.
   The more negative the aggregate score, the more likely home prices will rise.
2. Alternative embodiments to exemplary embodiment #1 include, instead of using 5-year and 10-year trailing averages (or projected averages or a hybrid of trailing and projected averages), using 1-year, 2-year, 3-year, 4-year, 5-year, 6-year, 7-year, 8-year, 9-year, 10-year, 11-year, 12-year, 13-year, 14-year, 15-year, 16-year, 17-year, 18-year, 19-year, 20-year, 21-year, 22-year, 23-year, 24-year, 25-year, 26-year, 27-year, 28-year, 29-year, 30-year, 31-year, 32-year, 33-year, 34-year, 35-year, 36-year, 37-year, 38-year, 39-year, 40-year, 41-year, 42-year, 43-year, 44-year, 45-year, 46-year, 47-year, 48-year, 49-year, 50-year, 51-year, 52-year, 53-year, 54-year, 55-year, 56-year, 57-year, 58-year, 59-year, 60-year, 61-year, 62-year, 63-year, 64-year, 65-year, 66-year, 67-year, 68-year, 69-year, 70-year, 71-year, 72-year, 73-year, 74-year, 75-year, 76-year, 77-year, 78-year, 79-year, 80-year, 81-year, 82-year, 83-year, 84-year, 85-year, 86-year, 87-year, 88-year, 89-year, 90-year, 91-year, 92-year, 93-year, 94-year, 95-year, 96-year, 97-year, 98-year, 99-year, or 100-year trailing averages (or projected averages or a hybrid of trailing and projected averages).
3. Alternative embodiments to exemplary embodiments #1 or #2 include, instead of calculating the average (or mean), calculating the median, mode, variance, or standard deviation.
4. Alternative embodiments to exemplary embodiments #1, #2, or #3 include, instead of calculating the average (or mean), median, mode, variance, or standard deviation, calculating the weighted average (or mean), weighted median, weighted mode, weighted variance, or weighted standard deviation.

While various embodiments of this invention have been described above, it should be understood that they have been presented by way of example only, and not limitation. Thus, the breadth and scope of this invention should not be limited by any of the above-described embodiments.

What is claimed is:

1. A method for determining whether home prices (or a home price index or home price indices) are more likely to rise or fall, comprising:
(a) Determining a plurality of factor scores, based on a plurality of factors; and
(b) Determining an aggregate score, based on a plurality of factor scores.

2. The method of claim 1, wherein determining a plurality of factor scores comprises an algorithm.

3. The method of claim 1, wherein determining an aggregate score comprises another algorithm.

4. The method of claim 1, wherein based on a plurality of factors comprises:
(a) Home prices (or a home price index or home price indices) at the local, Metropolitan Statistical Area, county, state, regional, or national level for a given period of time;
(b) Mortgage payments (or home price index mortgage payments or home price indices mortgage payments) at the local, Metropolitan Statistical Area, county, state, regional, or national level, which factor in mortgage interest rates, for a given period of time;
(c) Family incomes (or home price index family incomes or home price indices family incomes) at the local, Metropolitan Statistical Area, county, state, regional, or national level for a given period of time; and
(d) Home rents (or home price index home rents or home price indices home rents) at the local, Metropolitan Statistical Area, county, state, regional, or national level for a given period of time.

5. The method of claim 1, wherein based on a plurality of factor scores comprises:
The current values and historical values of the ratios below:
(a) (Home Prices)÷(Family Incomes);
(b) (Mortgage Payments)÷(Family Incomes);
(c) (Home Prices)÷(Home Rents); and
(d) (Mortgage Payments)÷(Home Rents).

6. The method of claim 2, wherein an algorithm comprises:
Comparing the current values to the historic values of the ratios below:
(a) (Home Prices)÷(Family Incomes);
(b) (Mortgage Payments)÷(Family Incomes);
(c) (Home Prices)÷(Home Rents); and
(d) (Mortgage Payments)÷(Home Rents).

7. The method of claim 3, wherein another algorithm comprises:
Aggregating the comparisons of the current values to the historic values of the ratios below into an aggregate score:
(a) (Home Prices)÷(Family Incomes);
(b) (Mortgage Payments)÷(Family Incomes);
(c) (Home Prices)÷(Home Rents); and
(d) (Mortgage Payments)÷(Home Rents).

8. The method of claim 4, wherein home prices (or a home price index or home price indices) comprises a measure of home prices (or a home price index or home price indices) at the local, Metropolitan Statistical Area, county, state, regional, or national level for a given period of time and are often expressed as:
(a) Home prices for the trailing month or quarter or year, or as projected home prices, or as a hybrid of trailing and projected home prices; or
(b) Average (or mean), median, or mode home price for a given area.

9. The method of claim 4, wherein mortgage payments (or home price index mortgage payments or home price indices mortgage payments) comprises a measure of mortgage payments (or home Nice index mortgage payments or home price indices mortgage payments) at the local, Metropolitan Statistical Area, county, state, regional, or national level, which factor in mortgage interest rates, for a given period of time and are often expressed as:
(a) Mortgage payments for the trailing month or quarter or year, or as projected mortgage payments, or as a hybrid of trailing and projected mortgage payments; or
(b) Average (or mean), median, or mode mortgage payment for a given area.

10. The method of claim 4, wherein family incomes (or home price index family incomes or home price indices family incomes) comprises a measure of family incomes (or home price index family incomes or home prices indices family incomes) at the local, Metropolitan Statistical Area, county, state, regional, or national level for a given period of time and are often expressed as:
(a) Family incomes for the trailing month or quarter or year, or as projected family incomes, or as a hybrid of trailing and projected family incomes; or
(b) Average (or mean), median, or mode family income for a given area.

11. The method of claim 4, wherein home rents (or home price index home rents or home price indices home rents) comprises a measure of home rents (or home price index home rents or home price indices home rents) at the local, Metropolitan Statistical Area, county, state, regional, or national level for a given period of time and are often expressed as:
(a) Home rents for the trailing month or quarter or year, or as projected home rents, or as a hybrid of trailing and projected home rents; or
(b) Average (or mean), median, or mode home rent for a given area.
